(19) United States
(12) Patent Application Publication
(10) Pub. No.: US 2007/0033243 A1
(43) Pub. Date: Feb. 8, 2007

(54) Microwave filter banks

(75) Inventor: Stephane Mallegol, Rennes Cedex (FR)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: MITSUBISHI DENKI KABUSHIKI KAISHA, Chiyoda-ku (JP)

(21) Appl. No.: 11/483,599

(22) Filed: Jul. 11, 2006

(30) Foreign Application Priority Data
Aug. 4, 2005 (EP) 05 291677.2

(51) Int. Cl. G06F 17/10

(52) U.S. Cl. 708/300

(57) ABSTRACT

The present invention concerns microwave filter banks of the type including at least one interconnection network and filters, each of said at least interconnection network comprising an input line and at least two output lines connected to said input line, a filter being connected to each output line of said interconnection network, the filters connected to said or to a given interconnection network having different cutoff frequencies and non-overlapping bandwidth. They are characterized in that the output lines of the or at least one interconnection network exhibit different characteristic impedances.

The present invention relates to microwave filter banks intended to dispatch electromagnetic energy from an input port toward a plurality of output ports depending on the frequency of the input signal and, conversely, to merge the electromagnetic energy from a plurality of output ports towards the input port. The invention also relates to a transceiver of the UWB (Ultra-Wide Band) type using such at least one filter bank acting either as an energy splitter or as a multiplexer/de-multiplexer.

The filter banks of the present invention can be used either as an energy splitter when the signal in a frequency band propagates from the input port to the output ports where only sub-bands are delivered or as an energy combiner when signals in different sub-bands propagate from the output ports to the input port. Such filter banks are thus said reciprocal. Furthermore, when said signals carry information or are representative of data, the filter banks of the invention can act either as multiplexers or as de-multiplexers depending on the propagation direction of the signals.

In the domain of the present invention, different technologies may be applied: stripline, microstrip or coplanar technologies. Stripline lines are conductive lines that are embedded in a dielectric and/or magnetic substrate which has its back and top sides recovered by a ground plane. Microstrip lines are also conductive lines but they are deposited on the topside of a dielectric and/or magnetic substrate, only the backside of the substrate being recovered by a ground plane. In the coplanar technology, the ground plane surrounds the lines, sometimes with the backside of the substrate also recovered by a plane connected to the ground. Though the invention is mainly described in relation with the microstrip technology, it may be understood that it is not limited thereto and includes also any embodiment that is performed with stripline and coplanar technologies.

The filter banks of the present invention generally comprise interconnection networks which filters are connected to. Different types of microwave interconnection networks are well-known is the art. One is a directional coupler essentially constituted of two lines lying one parallel to the other at a low distance in order to be coupled. More than two lines that are two by two linked can be also coupled resulting in the so-called Lange configuration. Examples of embodiments of such interconnection networks can be seen in the patent document US-A-2004/0113716.

Another type of microwave interconnection network can be seen in the Wilkinson power divider that is constituted of two quarter-wave line segments one extremity of each being connected to the input port of the network and the other to a respective output port, the two output ports being connected by a lumped resistor. Such a power divider is for example described in the patent document U.S. Pat. No. 4,367,445.

Other types of microwave interconnection networks are also well-known in the art but they are not described here. For example, a 1/N multiport power divider is described in the document authored by Masashi Nakatsugawa, entitled “A novel configuration for 1/N multiport power dividers using series/parallel transmission line division and a polyimide/alumina ceramic structure for HPA module implementation” and published in IEEE transactions on microwave theory and techniques, col 49, No 6, June 2001.

The drawback of the filter banks using the known microwave interconnection networks as those aforementioned is the fact that the input power on the input port is generally significantly attenuated on each of the output ports of the filter banks, for example by an 3 dB attenuation for a two output ports interconnection network. It results from such attenuation the need of amplification circuits. But these amplifiers cannot be passive circuits because they need an external bias. Note that the goal of the invention is to propose a passive circuit.

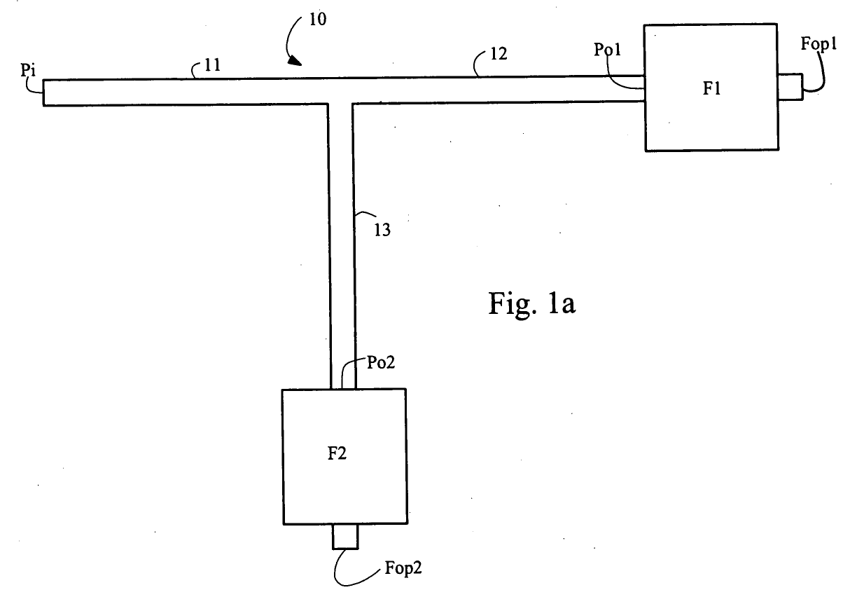

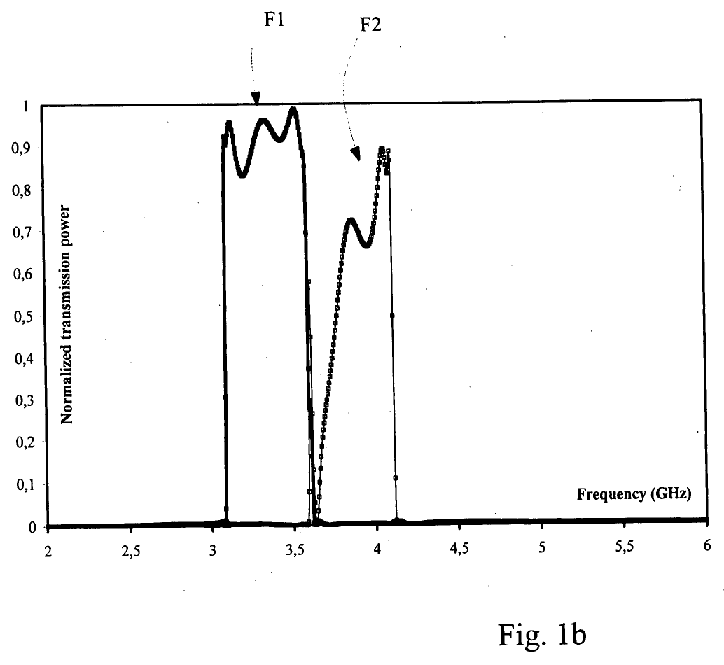

FIG. 1a shows an embodiment that may possibly be a dual filter bank. It comprises an interconnection network 10 having a general form of a tee, the horizontal line 11 on the left in the FIG. 1a being the input line including therefore an input port Pi, the other horizontal line 12 on the right being the first output line including therefore the first output port Po2 intended to be connected to the input port of a first filter F1 and the vertical line 13 being the second output line including therefore the second output port Po2 intended to be connected to the input of a second filter F2. The filters F1 and F2 are for example bandpass filters the cutoff frequencies of which are different and the bandwidths of which do not overlap. In order to match the impedance of the lines 12 and 13 to the respective impedances of the filters F1 and F2, which is generally 50 ohms, the sizes of the lines 12 and 13 are identical. The impedance of line 11 is also the same, generally 50 ohms, so that the sizes of the line 11 are also identical to the sizes of the lines 12 and 13.

FIG. 1b plots the transmission powers respectively at the respective outputs of the filters F1 and F2 versus the frequency of the input signal. One can note whereas the power on the output port Fop1 of the filter F1 is transmitted without significant loss, the power on the output port Fop2 of the filter F2 is affected by adverse losses, mainly at the lowest part of the frequency sub-band of the filter F2.

The present invention aims at solving the aforementioned problem by providing microwave filter banks that do not present the drawbacks mentioned above and that are therefore of such a structure that the power delivered on each of their output ports is not significantly attenuated compared to the power on the input port.

Indeed, a microwave filter bank according to the present invention is of the type including at least one interconnection network and filters, each of said at least interconnection network comprising an input line and at least two output lines connected to said input line, a filter being connected to each output line of said interconnection network, the filters connected to said or to a given interconnection network having different cutoff frequencies and non-overlapping bandwidth. It is characterized in that the output lines of the or at least one interconnection network exhibit different characteristic impedances.

Advantageously, the higher the cutoff frequency of a filter connected to an interconnection network is, the wider is the output line which said filter is connected to. Likewise, the lower the cutoff frequency of a filter connected to an interconnection network is, the longer is the output line which said filter is connected to.

According to an embodiment of the present invention, amongst the filters that are connected to a same interconnection network, those that have the lower and higher frequency cutoffs are respectively a lowpass filter and a highpass filter.

The invention also relates to a microwave filter bank that combines a plurality of filter banks as aforementioned in such a way that the input port of a subsequent filter bank is connected to one of the output ports of a previous filter bank and such that the bandwidths of the filters of this subsequent filter bank are included in the bandwidth of the filter of this previous filter bank the output port of which the subsequent filter bank is connected to.

The present invention also related to a transceiver of the UWB type, comprising a modulator for modulating input data with a predetermined number of frequency pulses in respective sub-bands, a demodulator for demodulating signals received in said sub-bands in order to recover the transmitted data and at least one filter bank intended either to receive and to merge all the frequency pulses in said respective sub-bands in order to transmit them or to receive and to split signals received in said sub-bands in order to deliver them to said demodulator. It is characterized in that said filter bank is a filter bank as aforementioned.

A transceiver according to the invention can be characterized in that said modulator includes a pulse generator and a filter bank as aforementioned for generating said predetermined number of frequency pulses in respective sub-bands.

The characteristics of the invention mentioned above, as well as others, will emerge more clearly from a reading of the following description given in relation to the accompanying figures, amongst which:

FIG. 1a shows a dual filter bank according to the prior art,

FIG. 1b plots the power delivered on each of the output ports of the two filters of the dual filter bank of the FIG. 1a versus the frequency of the input signal on the input port of the filter bank,

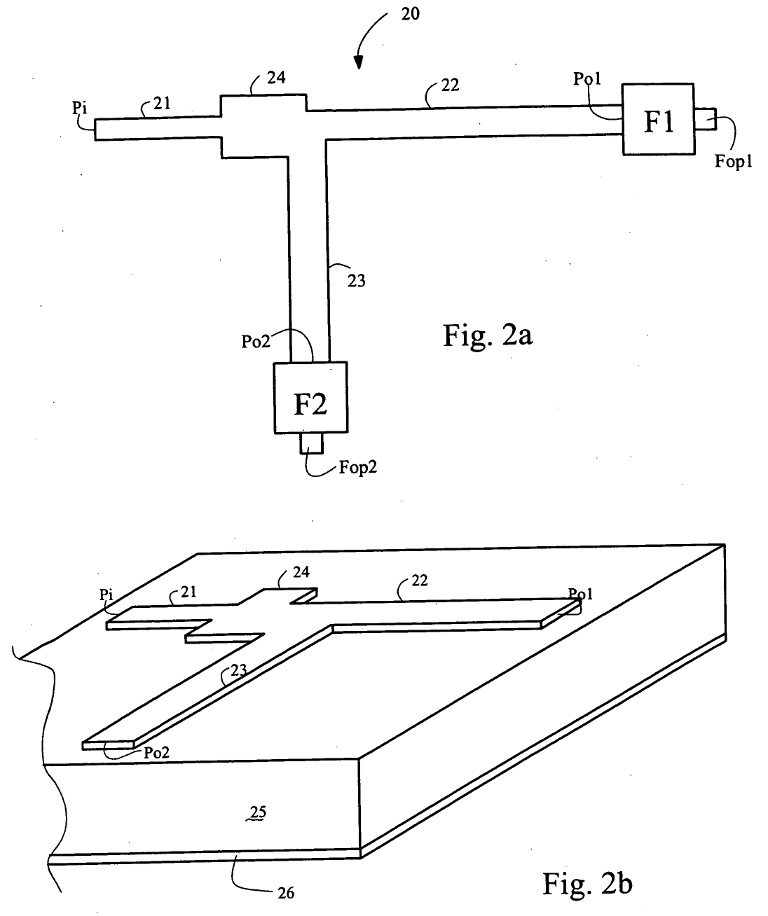

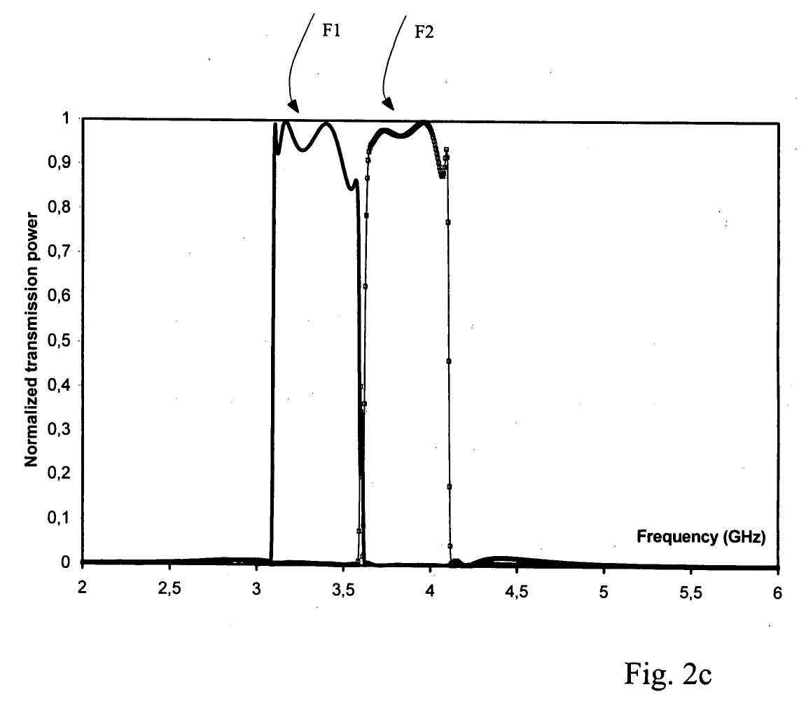

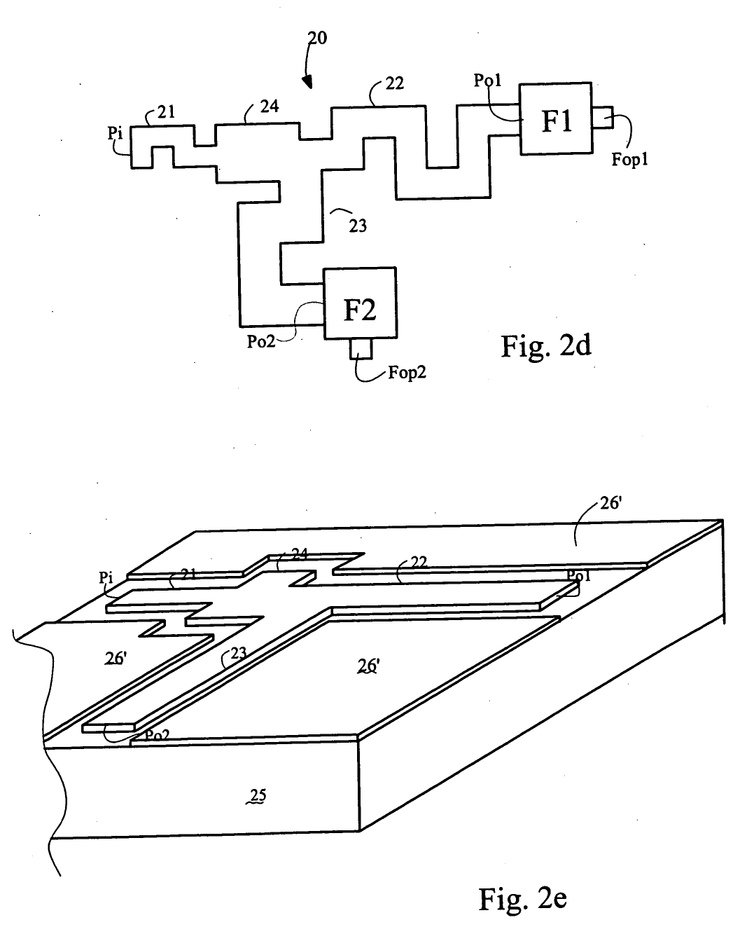

FIGS. 2a and 2b are respectively a top view and a perspective view of a dual filter bank according to an embodiment of the present invention using the microstrip technology,

FIG. 2c plots the power delivered on each of the output ports of the two filters of the dual filter bank of the FIGS. 2a and 2b versus the frequency of the input signal on the input port of the filter bank,

FIG. 2d and FIG. 2e show other respective embodiments of the dual filter bank according to the one depicted in FIGS. 2a and 2b,

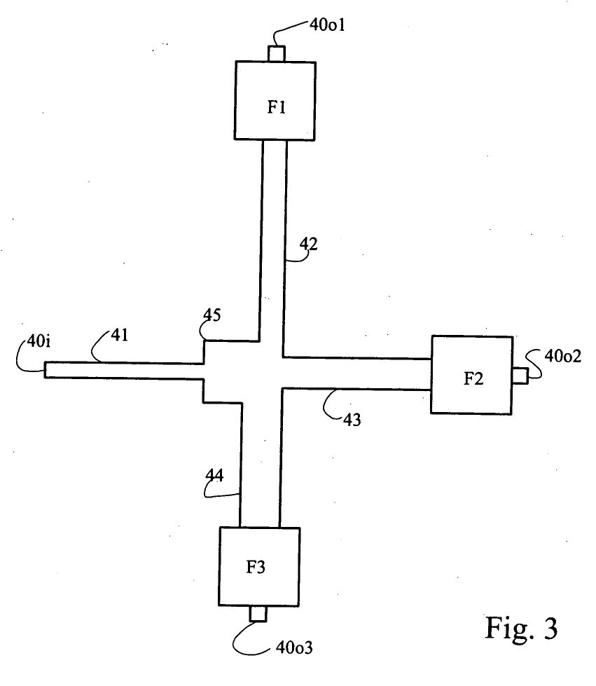

FIG. 3 shows a top view of a triple filter bank according to the present invention,

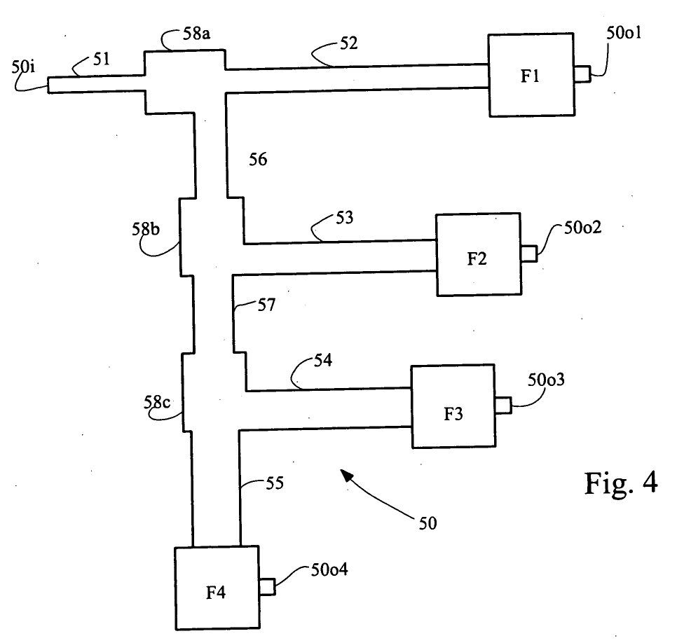

FIG. 4 shows a top view of a quadruple filter bank according to the present invention,

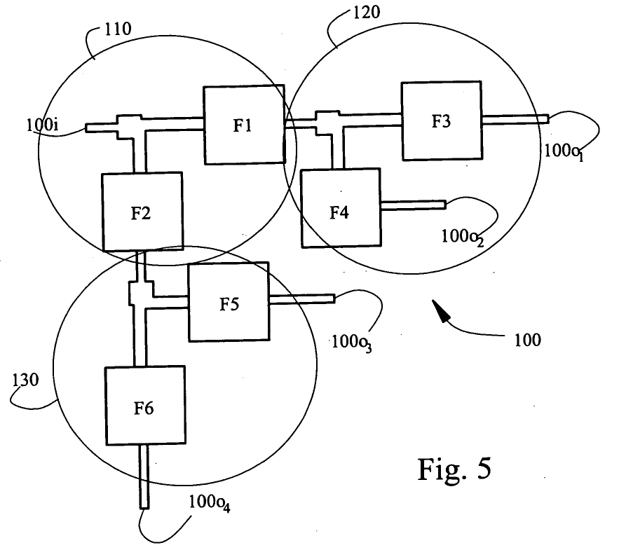

FIG. 5 shows a top view of a quadruple filter bank according to the present invention obtained by combining three dual filter banks according to the one described in relation with FIGS. 2a and 2b,

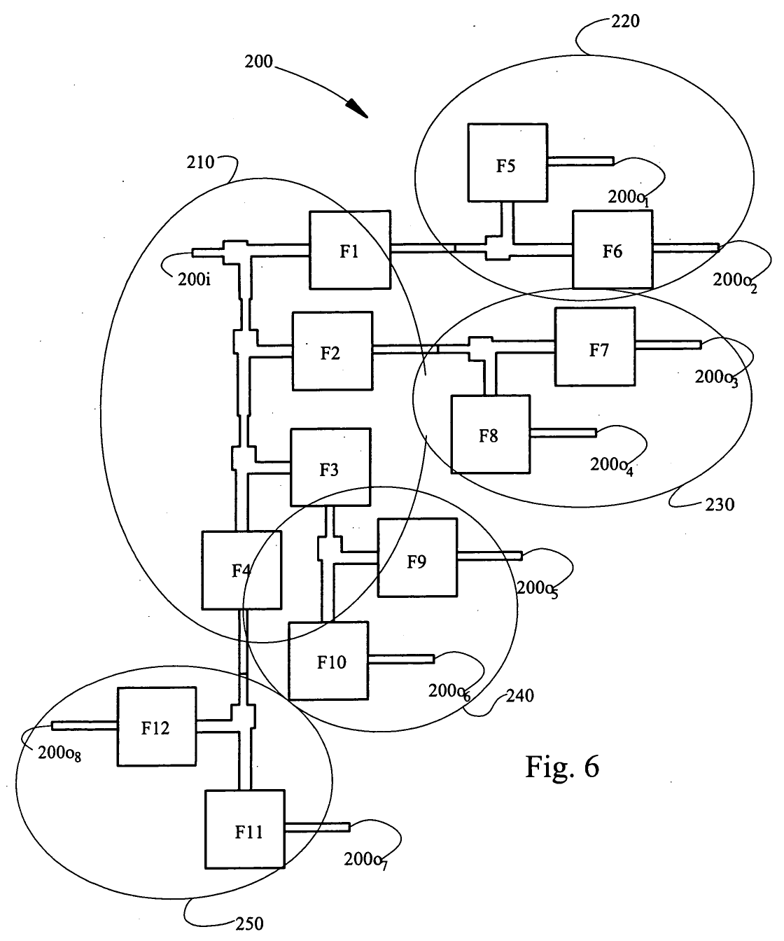

FIG. 6 shows a top view of an octuple filter bank according to the present invention obtained by combining a quadruple filter bank according to the one described in relation with FIG. 4 and four dual filter banks according to the one described in relation with FIGS. 2a and 2b,

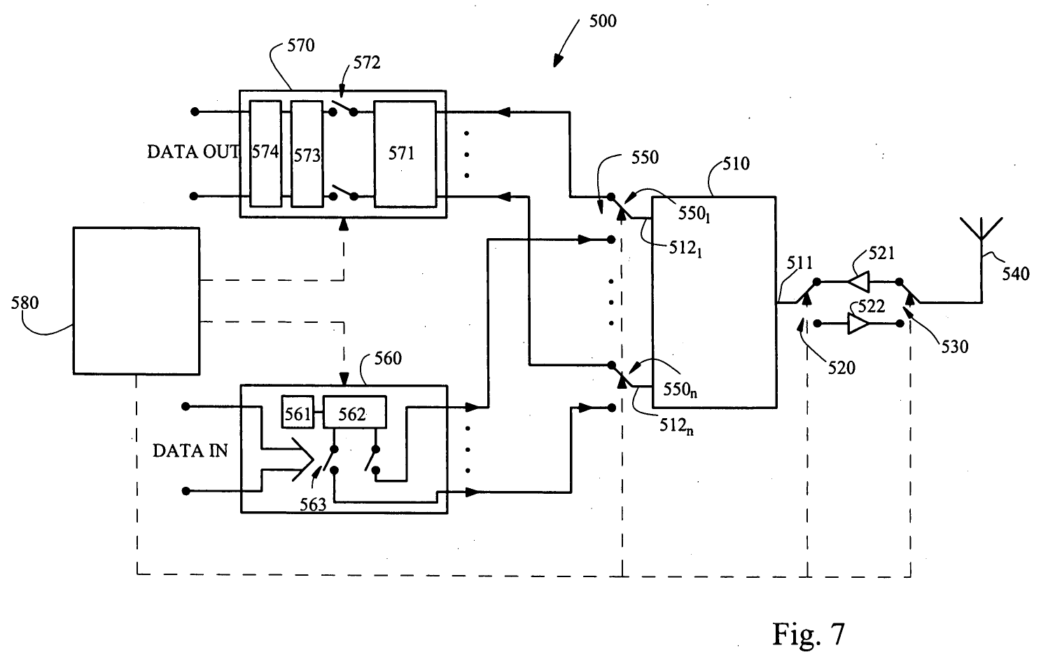

FIG. 7 is a schematic view of a transceiver of a transmission system of the UWB (Ultra-Wide Band) type using at least one hereinabove filter bank.

FIG. 2a shows a dual filter bank comprising an interconnection network 20 having a general form of a tee, the horizontal line 21 on the left in the FIG. 2a being the input line including therefore an input port Pi, the other horizontal line 22 on the right being the first output line including therefore the first output port Po1 and the vertical line 23 being the second output line including therefore the second output port Po2. The first output port Po1 is intended to be connected to an input of a filter F1 provided with an output port Fop1. Likewise, the first output port Po2 is intended to be connected to an input of a filter F2 provided with an output port Fop2. The filters F1 and F2 have different cutoff frequencies and non-overlapping bandwidths.

Note that the terminology “input” and “output” refers to the use of the filter bank as an energy splitter, but does not mean that it cannot be used as an energy combiner, since all the elements thereof are reciprocal, even the filters F1 and F2.

FIG. 2b shows the interconnection network 20 of a same dual filter bank according to the invention constituted by the lines 21, 22 and 23 printed on the top side of a substrate 25, the back side being constituted by a ground plane 26. The thickness of the printed conductive layer making up the lines 21 to 23 is referred to as t. The filters F1 and F2 are not represented for purposes of clarity of this FIG. 2b.

First line 21 is formed of a line the length and the width of which are intended for the line to exhibit a characteristic impedance for matching the impedance of the device connected to the input port Pi. Typically, the characteristic impedance of line 1 is 50 Ω.

Moreover, according to a characteristic of the present invention, output lines 22 and 23 are asymmetrical, which means that they exhibit two different characteristic impedances. In FIGS. 2a and 2b, the output lines 22 and 23 are of different sizes, mainly the lengths and the widths thereof are different.

Since the cutoff frequency of the filter F1 is lower than the cutoff frequency of the filter F2, the characteristic impedance of the transmission line 22 is higher than the characteristic impedance of the transmission line 23. Furthermore, the characteristic impedances of those lines 22 and 23 are lower than the one of line 21.

Determination of the characteristic impedance of a single microstrip line printed on a dielectric substrate can be based upon the equations presented in a document authored by E. Hammerstad and Φ. Jensen and entitled “Accurate models for microstrip computer aided design”. It can be seen in this document that, with a good accuracy, for a given thickness of the microstrip line printed on a dielectric substrate of a given relative dielectric constant, the characteristic impedance essentially depends on the width of the line. By applying such a principle, it results that line 23 and line 22 don't present the same widths: for instance, line 23 is wider than line 22.

As to the length of each line 22, 23, it may be determined when considering the variation versus the frequency of the input signal or versus the guided wavelength at the working frequency of the transmission coefficients at the intersection of the two lines 22 and 23. It can be demonstrated that since the cutoff frequency of the filter F1 is lower than the cutoff frequency of the filter F2, line 22 is longer than line 23.

At the intersection of the three lines 21, 22 and 23, a patch 24 is provided with, for example, a rectangular form the width of which is higher than those of lines 21 to 23 thus creating step changes in the width of lines 21 to 23 in the vicinity of their intersection. The characteristic impedance of the patch 4 is chosen to be equal to or lower than the characteristic impedance of line 21. Advantageously, the characteristic impedance of the patch 24 is chosen to be lower than the characteristic impedance of line 21 making optimum the reflection parameters level of the interconnection network 20.

FIG. 2c plots the normalized transmission power over the output ports of the respective filters F1 and F2 of the dual filter bank represented on FIGS. 2a and 2b versus the frequency of the in put signal on the input port Pi. The dual filter bank that was used to plot the FIG. 2c was made up on a ceramic substrate the dielectric constant of which is equal to the complex number (10.5-10⁻³ j) and the relative permeability of which is 1 (the substrate was a dielectric material). The thickness of the substrate was 0.635 mm. The printed lines had a thickness of 17 μm.

The length of line 22 was 7.5 mm and the width thereof was 0.75 mm whereas the length of line 23 was 5 mm and the width thereof was 0.87 mm. The length of line 21 was 3 mm and the width thereof was of 0.576 mm. As to the patch 24, the length thereof was 2 mm whereas its width was 1.67 mm.

It can be seen that the normalized transmission powers for frequency range from 3.1 GHz to 4.1 GHz over the two outputs of the respective filters F1 and F2 are equal to 1 with an error less than 5 per cent.

According to an alternative embodiment of the dual filter bank depicted on FIGS. 2a and 2b, and in order to reduce its size, at least one of the lines 21, 22, 23 is a meander line as it can be seen in FIG. 2d (For instance, lines 21, 22 and 23 are meander lines). The width and the total length of each line 21, 22 and 23 is equal to the width and the total length of each corresponding line 21, 22 and 23 of the embodiment depicted on FIG. 2a and FIG. 2b.

Note that the invention is not limited to the use of the microstrip technology. Stripline technology can be used with the required adaptation that this use implies. An embodiment using the coplanar technology can be seen in FIG. 2e wherein, compared to FIG. 1c, the backside ground plane 6 has been suppressed and replaced by a topside ground plane 26′ surrounding the interconnection network.

FIG. 3 depicts another filter bank that complies with the principle of the present invention. It comprises an interconnection network 40 having one input line 41 and three output lines 42, 43 and 44. The input line 41 forms the input port Pi of the filter bank. The output ports of the interconnection network 30 are respectively connected to the inputs of three filters F1, F2, and F3, the cutoff frequencies of which are different (the lower cutoff frequency for the filter F1, then the filter F2, and the higher cutoff frequency for the filter F3) and the bandwidths of which do not overlap.

First line 41 has a length and a width intended for the line to exhibit a characteristic impedance for matching the impedance of the device connected to the input port Pi. Typically, the characteristic impedance of line 1 is 50 Ω.

According to the present invention, the characteristic impedances of the output lines 42, 43 and 44 intended to be connected to the filters F1, F2, and F3 exhibit different characteristic impedances. Moreover, since the cutoff frequencies of the respective filters F1 to F3 are as such described above, the impedance characteristic of the line 42 is higher than the one of line 43 and the latter is also higher than the one of line 44. To do so, line 44 is wider than line 43 and line 43 is wider than line 42. Furthermore, line 42 is longer than line 43 and line 43 is longer than line 44.

A patch 45 is provided at the intersection of the lines 42, 43 and 44 in order to avoid undesirable coupling between the three lines 42, 43 and 44.

FIG. 4 depicts still another filter bank that complies to the principle of the present invention. It is a quadruple filter bank. It comprises an interconnection network 50 including one input line 51 and four output lines 52 to 55, as well linking lines 56 and 57 respectively lying between the output lines 52 and 53 and the output lines 53 and 54. The line 51 forms the input port Pi of the filter bank. The output ports of the interconnection network 50 are respectively connected to the inputs of four filters F1, F2, F3 and F4, the cutoff frequencies of which are different (the lower cutoff frequency for the filter F1, then the filter F2, then the filter F3 and the higher cutoff frequency for the filter F4) and the bandwidths of which do not overlap.

First line 51 has a length and a width intended for the line to exhibit a characteristic impedance for matching the impedance of the device connected to the input port Pi. Typically, the characteristic impedance of line 1 is 50 Ω.

According to the present invention, the characteristic impedances of the output lines 52, 53, 54 and 55 of the interconnection network 50 intended to be connected to the filters F1 to F4 exhibit different characteristic impedances. Moreover, since the cutoff frequencies of the respective filters F1 to F4 are as such described above, the impedance characteristic of the line 52 is higher than the one of line 53, the latter being also higher than the one of line 54 and the latter being also higher than the one of line 55. To do so, taking into account the frequency characteristics of the filters F1 to F4, line 55 is wider than line 54, line 54 is wider than line 53, and line 53 is wider than line 52. Furthermore, line 52 is longer than line 53, line 53 is longer than line 54, and line 54 is longer than line 55.

Patches 58a, 58b and 58c are provided at the respective intersections of the line 52 with the linking line 56, of the line 53 with the linking line 57 and of the lines 54 and 55.

By combining two or more filter banks similar to at least one of those described in relation with FIGS. 2a, 2b, 2d, 2e, 3 and 4, it is possible to make up another filter bank of greatest order. The combination is made such that the input port of a subsequent filter bank is connected to one of the output ports of a previous filter bank and such that the bandwidths of the filters of this subsequent filter bank are included in the bandwidth of the filter of this previous filter bank the output port of which the subsequent filter bank is connected to.

Thus, by combining three dual filter banks 110, 120 and 130 similar to the dual filter bank previously described in relation with FIGS. 2a and 2b, one can obtain the quadruple filter bank 100 depicted on FIG. 5. It has an input 100i and four outputs 100o1 to 100o4. The first dual filter bank 110 has its input port 100i that constitutes the input port of the filter bank 100. The input port of the second dual filter bank 120 is connected to the output of the filter F1 of the dual filter bank 110 and the input port of the third dual filter bank 130 is connected to the output of filter F2 of the first dual filter bank 110. The bandwidths of the two filters F3 and F4 of the second dual filter bank 120 are included in the bandwidth of the filter F1 of the first filter bank 110 and the bandwidths of the two filters F5 and F6 of the third dual filter bank 130 are included in the bandwidth of the filter F2 of the first filter bank 110.

It must be understood that the dimensions of the interconnection network of the dual filter banks 110, 120 and 130 are generally not identical but depend on the electromagnetic properties of each couple of filters F1, F2; F3, F4 and F5, F6.

For example, each filter presents an elliptic response. The order of the filters F1 and F2 is equal to 5 whereas the one of the other filters F3 to F6 is three.

For example, according to an embodiment for a 3.1-4.1 GHz quadruple filter bank, the bandwidth of the filter F1 is 3.1-3.6 GHz whereas the bandwidth of the filter F2 is 3.6-4.1 GHz and the bandwidths of filters F3 to F6 are respectively 3.1-3.35 GHz, 3.35-3.6 GHz, 3.6-3.85 GHz and 3.85-4.1 GHz.

Note that at least one of the couples of filters F1, F2; F3, F4 and F5, F6 of the respective dual filter bank 110, 120 and 130 can be such that one is a lowpass filter whereas the other one is a highpass filter, the two filters being complementary.

More generally, amongst the filters that are connected to a same interconnection network, those that have the lower and higher frequency cutoffs may be respectively a lowpass filter and a highpass filter.

Note that the quadruple filter bank 100 of FIG. 5 is denoted as serial since filters F3 and F4 are in series with filter F1 and filters F5 and F6 are in series with filter F2.

Likewise, by combining a quadruple filter bank 210, for instance a quadruple filter bank according to the embodiment depicted on FIG. 4 but it could be according to the one described in relation with FIG. 5, and four dual filter banks 220, 230, 240 and 250 similar to the dual filter bank previously described in relation with FIGS. 2a and 2b, one can obtain an octuple filter bank 200 as the one depicted in FIG. 6. It has one input 200i and eight outputs 200o1 to 200o8. The output of the filter F1 of the quadruple filter bank 210 is connected to the input line of the dual filter bank 220 comprising the filters F5 and F6. Likewise, the output of the filter F2 of the quadruple filter bank 210 is connected to the input line of the dual filter bank 230 comprising two filters F7 and F8, the output of the filter F3 is connected to the input line of the dual filter bank 240 comprising filters F9 and F10 and the output of the filter F4 is connected to the input line of the dual filter bank 250 comprising filters F11 and F12.

In all the configurations above shown, the filters may be of various types. For example, they can be of the type using Bulk Acoustic Resonators described in the document entitled “Bulk acoustic resonators and filters for applications above 2 GHz” described by K. M. Lakin and al. and published in IEEE 2002. They may be of the type using microstrip technology or coplanar technology as described in the document entitled “3D integrated narrowband filters for millimeter-wave wireless applications” by E. Rius and al. in IEEE 2002, or in the document entitled “High-dielectric constant stripline band-pass filters” by Frederick Winter and all in IEEE 1991, or in the document authored by Ching-Luh Hsu, Fu-Chieh Hsu and Jen-Tsai Kuo and entitled “Microstrip Bandpass Filters for Ultra-Wideband (UWB) Wireless communications” published in IEEE 2005. They may be of the type using coplanar technology as the one described in the document entitled “A novel compact coplanar filter” by T. Paillot in IEEE 2002. They can be also of the type described in the document entitled “Hybrid tunable microwave devices based on schottky-diode varactors” published in Proceedings of the European Microwave Association Vol. 1; June 2005; and authored by Emmanuel Pistono and al.

FIG. 7 depicts a transceiver 500 according to the invention. It comprises a filter bank 510 acting here either as a multiplexer or as de-multiplexer depending on the propagation direction of the signals (it will be said, for purposes of simplicity, multiplexer), said filter bank 510 being in accordance with one of the embodiments represented in one of the FIGS. 2a, 2b, 2d, 2e, 3, 4, 5 and 6, or with one embodiment derived from one of these embodiments. The multiplexer 510 has a port 511 which is connected to the common contact of a controlled switch 520, the two other contacts thereof being respectively connected to the output of an amplifier 521 and the input of another amplifier 522. The input of the amplifier 521 is connected to a contact of another switch 530 whereas the output of the amplifier 522 is connected to another contact of the switch 530. The common contact of the switch 530 is connected to an antenna 540.

Each port 512j (j=1 to n) of the multiport 512 of the multiplexer 510 is connected to the common contact of a controlled switch 550j amongst all the switches of a multiswitch 550, the two other contacts being respectively connected to an output port of a multiport of a modulator 560 and to an input port of a multiport of a demodulator 570.

The modulator 560 includes a pulse generator 561 producing a basic pulse sequence having a uniform frequency spectra in a frequency band of the transceiver, this pulse generator 561 delivered to an energy splitter 562 despatching on respective outputs the energy of the pulse contained in a plurality of sub-band of said frequency band. The energy splitter 562 is formed by a filter bank in accordance with one of the embodiments represented in one of the FIGS. 2a, 2b, 2d, 2e, 3, 4, 5 and 6, or with one embodiment derived from one of these embodiments. Each output of said energy splitter is connected to one of the switches of an encoder 563 controlled by each bit of the input data and delivering in the corresponding frequency sub-band a modulated pulse sequence. All the outputs of the encoder 563 form the output multiport of the modulator 560.

The modulator 560 is thus provided for modulating input data with a predetermined number of frequency pulses in respective sub-bands.

The demodulator 570 includes recovery means 571 intended to recover the energy delivered over each input ports of the multiport thereof, synchronisation means 572 constituted by a plurality of controlled switches, integrating means 573 and comparator means 574 intended to compare the signals delivered by said integrating means 573 with predetermined threshold values and to deliver the output data under the form of a plurality of bits. The synchronisation means 572 and the integrating means 573 are intended to deliver over each input of the comparator means 574 a signal representative of the power carried in each sub-band during the channel delay.

The demodulator 570 is thus provided for demodulating signals received in said sub-bands in order to recover the transmitted data.

A controller 580 is provided in order to control the switches 520 and 530, the multiswitch 550 and the modulator 560 and the demodulator 570 as well. When the transceiver 500 is intended to transmit data, the multiswitch 550 is in a position in which the modulator 560 is connected to the filter bank 510, acting then as a multiplexer, the switch 520 is in a position in which the filter bank 510 is connected to the amplifier 522 and the switch 530 is in a position in which the amplifier 522 feeds the antenna 540. When the transceiver 500 is intended to receive data, the switch 530 is in a position in which the antenna 540 feeds the amplifier 521, the switch 520 is in a position in which the amplifier 521 is connected to the filter bank 510, acting then as a de-multiplexer, and the multiswitch 550 is in a position in which the filter bank 510 is connected to the demodulator 570.

The filter bank 510 is thus intended either to receive and to merge all the frequency pulses generated by the modulator 560 in said respective sub-bands in order to transmit them by means of the amplifier 522 and the antenna 540 or to receive and to split signals received in said sub-bands by means of the antenna 540 and the amplifier 521 in order to deliver them to said demodulator 570.

1) Microwave filter bank including at least one interconnection network and filters, each of said at least interconnection network comprising an input line and at least two output lines connected to said input line, a filter being connected to each output line of said interconnection network, the filters connected to said or to a given interconnection network having different cutoff frequencies and non-overlapping bandwidth, characterized in that the output lines of the or at least one interconnection network exhibit different characteristic impedances, these characteristic impedances being also different from the input line characteristic impedance which is intended to match the impedance of the device connected thereto.

2) Microwave filter bank according to claim 1, characterized in that the higher the cutoff frequency of a filter connected to an interconnection network is, the wider is the output line which said filter is connected to.

3) Microwave filter bank according to claim 1 or 2, characterized in that the lower the cutoff frequency of a filter connected to an interconnection network is, the longer is the output line which said filter is connected to.

4) Microwave filter bank according to one of the previous claims, characterized in that at least one line is a meander line.

5) Microwave filter bank according to one of the previous claims, characterized in that the lines of said at least interconnection network are lines in a microstrip technology, or in a stripline technology or in a coplanar technology.

6) Microwave filter bank according to one of the previous claims, characterized in that said filters are bandpass filters.

7) Microwave filter bank according to one of the previous claims, characterized in that amongst the filters that are connected to a same interconnection network, those that have the lower and higher frequency cutoffs are respectively a lowpass filter and a highpass filter.

8) Microwave filter bank, characterized in that it combines a plurality of filter banks each according to one of the previous claims in such a way that the input port of a subsequent filter bank is connected to one of the output ports of a previous filter bank and such that the bandwidths of the filters of this subsequent filter bank are included in the bandwidth of the filter of this previous filter bank the output port of which the subsequent filter bank is connected to.

9) Transceiver of the UWB type, comprising a modulator for modulating input data with a predetermined number of frequency pulses in respective sub-bands, a demodulator for demodulating signals received in said sub-bands in order to recover the transmitted data and at least one filter bank intended either to receive and to merge all the frequency pulses in said respective sub-bands in order to transmit them or to receive and to split signals received in said sub-bands in order to deliver them to said demodulator, characterized in that said filter bank is according to a microwave filter bank of one claim 1 to 8.

10) Transceiver of the UWB type according to claim 9, characterized in that said modulator includes a pulse generator and a filter bank according to claim 1 to 8 for generating said predetermined number of frequency pulses in respective sub-bands.
